(19) United States
(12) Patent Application Publication
(10) Pub. No.: US 2012/0181917 A1
(43) Pub. Date: Jul. 19, 2012

(54) Tube Assembly Having Electrical Connection Structure

(76) Inventor: Chia-Yen Lin, Dongguan City (CN)

(21) Appl. No.: 13/158,386

(22) Filed: Jun. 11, 2011

(30) Foreign Application Priority Data
Jan. 13, 2011 (TW) 100101196

(51) Int. Cl. H01J 5/50

(52) U.S. Cl. 313/318.12

(57) ABSTRACT

A tube assembly having an electrical connection structure is disclosed, which includes a tube member and a connection member, wherein the tube member has two opposite ends respectively formed with a first engaging portion, and a second engaging portion which is engageable with the first engaging portion, and the tube member includes an electrical module including a positive and negative conducting pieces, and the positive and negative conducting pieces are respectively electrically connected to the light-emitting devices positioned in the tube member, and the positive and negative conducting pieces respectively have two opposite ends respectively formed with a first and second positive contacts, and a first negative and second negative contacts; wherein the connection member has at least two engaging portions engageable with the engaging portion of the tube member so that the tube members can be electrically connected, and the light-emitting devices positioned within such tube members can be illuminated.

### BACKGROUND OF THE INVENTION

1. Field of the Invention

The present invention relates to a tube assembly, and more particularly, relates to a tube assembly having an electrical connection structure for electrically connecting a plurality of tube members so that the light-emitting devices positioned within such tube members can be illuminated.

2. The Prior Arts

Recently, more demands are put on the educational toys. For most of the popular educational toys, they have not only beautiful appearance, but also high-function design. The construction toys that can develop and train hand-eye coordination have been a favorite toy for children of all age. The construction toys having the short or long tube members with the connection members can help children to learn and build 3D objects.

To make the construction toys visually more appealing, a current approach has put emphasis on using the different colors of the tube members and the connection members to attract more children to play. The improved construction toys can be illuminated when they are connected to a power source.

### SUMMARY OF THE INVENTION

One objective of the present invention is to provide a tube assembly that includes a tube member and a connection member. The tube assembly can be formed by assembling a plurality of tube members together, or assembling one or more of the tube members with one or more of the connection members. After assembling, the light-emitting devices disposed in each tube member can be illuminated when the electricity is supplied to the tube assembly. Therefore, the visual effect of the tube construction toys can be enhanced.

In order to accomplish the above objective, the present invention provides a tube assembly that comprises: a tube member, which is hollow and light-transmittable, the tube member having two opposite ends respectively formed with a first engaging portion and a second engaging portion, and including an electrical module and at least one light-emitting device positioned therein, the electrical module including a positive conducting piece and a negative conducting piece, the positive and negative conducting pieces being respectively electrically connected to the light-emitting device, the positive conducting piece having two opposite ends respectively formed with a first positive contact and a second positive contact, the negative conducting piece having two opposite ends respectively formed with a first negative contact and a second negative contact, and the positive and negative contacts being respectively positioned within the first and second engaging portions of the tube member; and a connection member, including a hollow body provided with at least two engaging portions, the at least two engaging portions being engaged with the first engaging portion of the tube member, the hollow body comprising an electrically conductive module, the electrically conductive module including a positive conductive piece and a negative conductive piece, the positive conductive piece having two opposite ends respectively formed with an elastic positive contact piece, the negative conductive piece having two opposite ends respectively formed with an elastic negative contact piece, the elastic positive and negative contact pieces being respectively positioned within the engaging portions of the connection member.

When the first or the second engaging portion of one tube member is engaged with the second or the first engaging portion of another tube member, or when the first engaging portions of two or more of tube members are engaged with two or more of the engaging portions of the connection members, the first positive contact and the first negative contact positioned within the first engaging portion will respectively contact with the second positive contact and the second negative contact positioned within the second engaging portion, or respectively contact with the elastic positive and negative contact pieces of the engaging portions of the connection members, so that an electric circuit is formed. The electrically connected light-emitting devices positioned in the tube members can be illuminated when any one of the tube member is connected to a power source.

According to another embodiment, an integrally formed tube piece comprises a tube member having two opposite ends respectively integrally formed with a connection member, the connection member integrally formed with the tube member having more than one engaging portion, and the tube member integrally formed with the connection member further comprises: a positive conducting piece having more than one positive contacts respectively positioned within the engaging portions of the connection member; a negative conducting piece having more than one negative contacts respectively positioned within the engaging portions of the connection member and disposed opposite to the positive conducting piece; and at least one light-emitting device electrically connected to the positive and negative conducting pieces.

### BRIEF DESCRIPTION OF THE DRAWINGS

The present invention will become more apparent by describing embodiments thereof in detail with reference to the accompanying drawing in which:

FIG. 1 is an exploded view showing the first preferred embodiment of the present invention;

FIG. 2A is a cross-sectional view of a tube member according to the first preferred embodiment of the present invention;

FIG. 2B is a cross-sectional view of a tube member according to the second preferred embodiment of the present invention;

FIG. 3 is a cross-sectional view of a tube assembly according to the first preferred embodiment of the present invention;

FIG. 4 is a cross-sectional view of a tube member assembled with a power supply module according to the first preferred embodiment of the present invention;

FIG. 5 is a cross-sectional view of a tube member engaged with a connection member according to the first preferred embodiment of the present invention;

FIG. 6 is a cross-sectional view of a connection member according to the second preferred embodiment of the present invention;

FIG. 7 is a cross-sectional view of a connection member according to the third preferred embodiment of the present invention;

FIG. 8 is a schematic view showing a tube assembly according to the third preferred embodiment of the present invention;

FIG. 9 is a schematic view showing a tube member integrally formed with two connection members according to one embodiment of the present invention;

FIG. 10 is a schematic view showing a tube member integrally formed with two connection members according to another embodiment of the present invention;

FIG. 11 is a schematic view showing a tube member integrally formed with two connection members according to another embodiment of the present invention;

FIG. 12 is a schematic view showing a tube member integrally formed with two connection members according to another embodiment of the present invention; and

FIG. 13 is a schematic view showing a tube member integrally formed with two connection members according to another embodiment of the present invention.

### DETAILED DESCRIPTION OF THE PREFERRED EMBODIMENTS

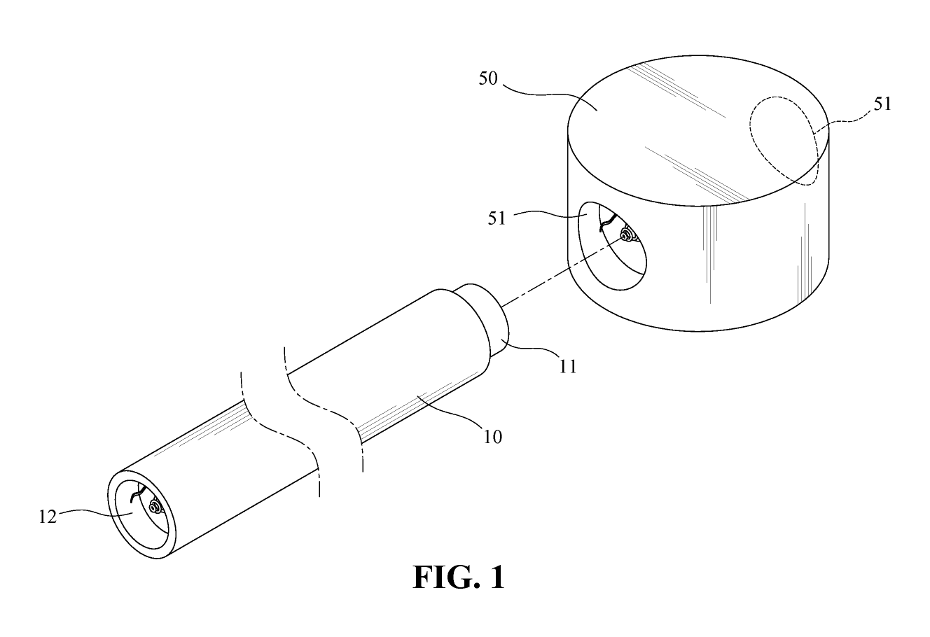

FIG. 1 is a schematic view illustrating a preferred embodiment of the present invention, which comprises one or more of tube members 10 and one or more of connection members 50.

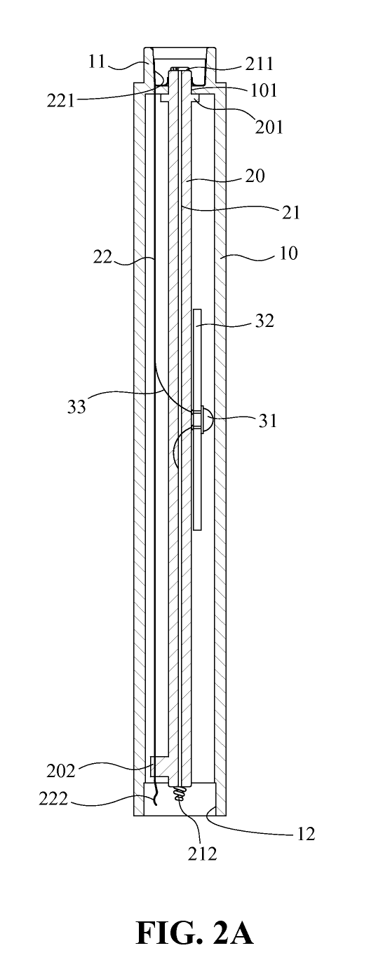

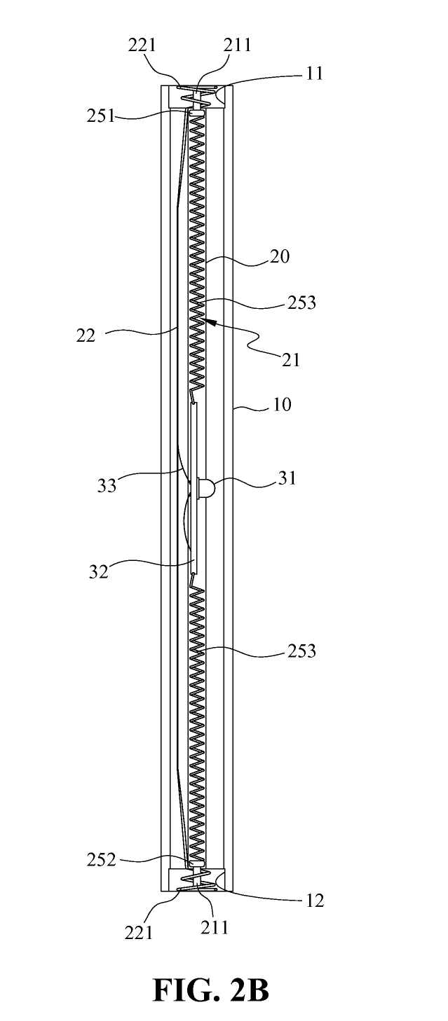

Referring to FIG. 2A, the tube member 10 is a hollow cylindrical tube which is light-transmittable, and has opposite first and second ends. The first end is a closed end provided with a through-hole 101, and having a first engaging portion 11 with an annular shape extending axially outward from the first end. The second end of the tube member 10 is an open end and serves as a second engaging portion 12 having an inner diameter that matches with the outer diameter of the first engaging portion 11, such that the first engaging portion 11 is receivable in engagement with the second engaging portion 12. In the preferred embodiment of the present invention, the first engaging portion 11 is a male member and the second engaging portion is a female member 12.

The tube member 10 comprises an electrical module. The electrical module comprises an insulating fixed column 20, and a positive conducting piece 21 and a negative conducting piece 22 respectively positioned in an inside and outside of the fixed column 20. Two opposite ends of the fixed column 20 are respectively formed with the first and second affixing portions 201 and 202. The first affixing portion 201 has a disc shape. A portion of the fixed column 20 protruded beyond the first affixing portion 201 is positioned within the first engaging portion 11, while the first affixing portion 201 abuts against an inner rim of the through-hole 101. The second affixing portion 202 is protruded radially from the wall of the lower end of the fixed column 20 in order to fix the negative conducting piece 22.

The positive conducting piece 21 has two ends that respectively form a first positive contact 211 and a second positive contact 212. In the preferred embodiment, the positive conducting piece 21 has an elongated shape that is positioned in an inside of the fixed column 20 and extends in an axial direction. The first positive contact 211 has a planar shape positioned on the top of the fixed column 20. The second positive contact 212 has a spiral shape that protrudes out of the bottom surface of the fixed column 20 and is positioned within the second engaging portion 12.

The negative conducting piece 22 has two ends that respectively have a first negative contact 221 and a second negative contact 222. In the preferred embodiment, the negative conducting piece 22 is formed in a long narrow strip shape. The first negative contact 221 has a bowl shape including an outer circumferential wall, an inner circumferential wall, and a bottom portion between the outer and inner circumferential walls. The outer circumferential wall has an outer diameter that matches with the inner diameter of the first engaging portion 11, so that it can contact with the inner lateral wall of the first engaging portion 11. The central region of the first negative contact 221 has a through-hole, and the inner circumferential wall of the first negative contact 221 is extended upward along the wall of the through-hole. The inner circumferential wall has an inner diameter matched with the outer diameter of the fixed column 20 so that the first negative contact 221 can be mounted around an upper portion of the fixed column 20. The second negative contact 222 of the negative conducting piece 22 is bent to form an elastic piece positioned within the second engaging portion 12 of the tube member 10.

One or more light-emitting devices are also provided in the tube member 10. The light-emitting devices are electrically connected with the positive and negative conducting pieces 21 and 22. In the preferred embodiment, the light-emitting device can be a light-emitting diode 31 mounted on a circuit board 32. The circuit board 32 has conducting wires 33 that are respectively connected with the positive and negative conducting pieces 21 and 22 of the electrical module.

FIG. 2B illustrates another embodiment that is generally similar to the previous embodiment except the structures of the positive and negative conducting pieces.

In this embodiment, the positive and negative conducting pieces 21 and 22 are disposed in the inside and the outside of the fixed column 20. The fixed column 20 is hollow. The positive conducting piece 21 is consisted of an upper conductive pin 251, a lower conductive pin 252, and an upper and a lower spring 253. One end of the upper conductive pin 251 and one end of lower conductive pin 252 protrude out of two ends of the fixed column 20 to respectively form the first and the second positive contacts 211, and the other ends of the upper and lower conductive pins 251 and 252 are respectively in contact with the upper and lower springs 253 so that the upper and lower conductive pins 251 and 252 are retractable and extendible. The springs 253 are also electrically connected to the circuit board 32 and the light-emitting diodes 31, which is mounted on the circuit board 32.

Two negative contacts 221 in the form of coil spring are respectively formed at the two ends of the negative conducting piece 22. The coil spring serving as the negative contact 221 is in a reverse cone shape, which has a diameter that decreases from top to bottom, and the two negative contacts 221 in the form of coil spring are surrounded around the upper and lower conductive pins 251 and 252.

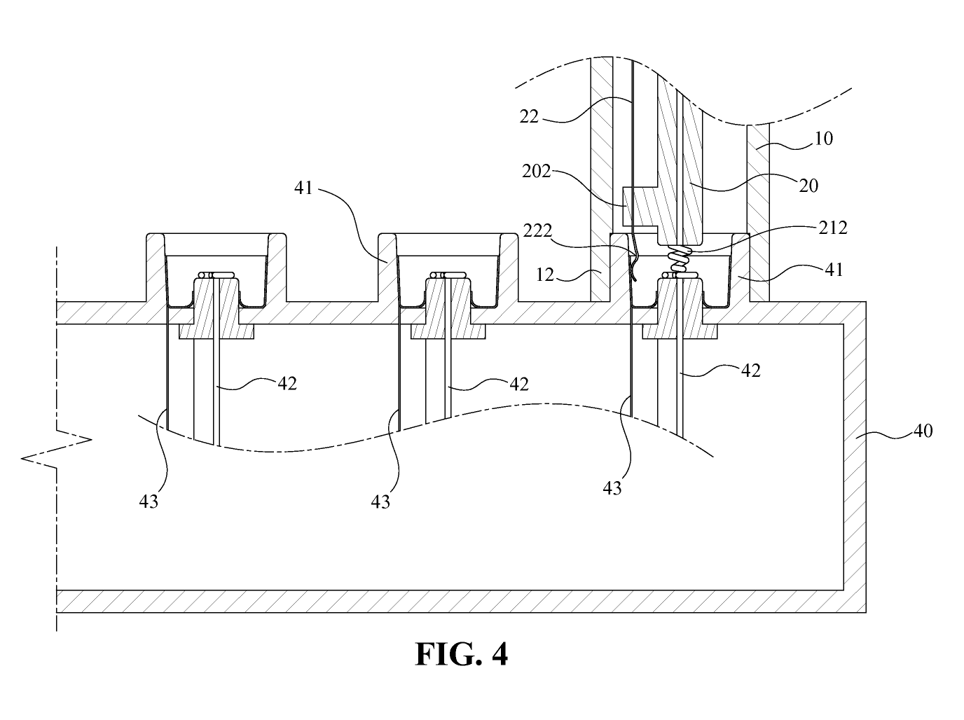

In the preferred embodiment, a power source is also provided for the light-emitting device. As shown in FIG. 4, the power supply module 40 has the first engaging portion 41 or the second engaging portion (not shown) which can engage with the second engaging portion 12 or the first engaging portion 11 of the tube member 10. In this embodiment, the power supply module 40 includes a plurality of the first engaging portions 41 inside of which the positive and negative conductive pieces 42 and 43 are provided. The positive and negative conductive pieces 42 and 43 are electrically connected to one or more batteries (not shown). When the second engaging portion 12 of the tube member 10 is engaged with the first engaging portion 41 of the power supply module 40, the tube member 10 can be electrically connected to the power supply module 40 to receive the electricity.

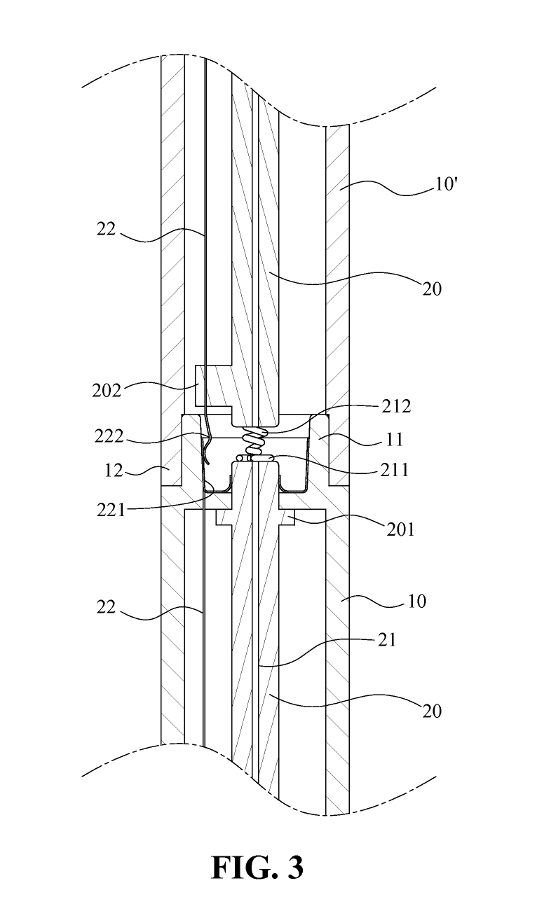

Referring to FIG. 3, when another tube member 10′ is assembled with the tube member 10, the tube member 10 receives the electricity from the power supply module 40, and meanwhile the tube member 10′ also receives the electricity from the power supply module 40 via the electrical module of the tube member 10.

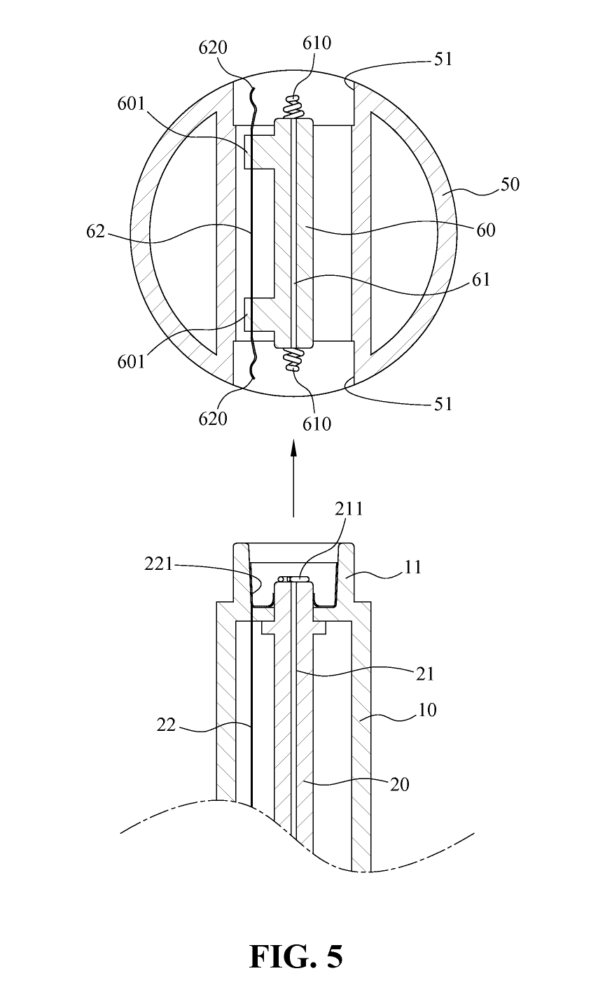

The assembly of the tube members 10 and 10′ can be further engaged with the connection member 50 to form a construction assembly. The connection member 50 also has an electrical connection structure. As shown in FIG. 5, the connection member 50 has a hollow body, and the engaging portions 51 are provided on two opposite sidewalls of the hollow body. In the preferred embodiment, the hollow body of the connection member 50 is in a cylindrical shape, and the number of the engaging portions 51 is two, and the engaging portions are in the form of female sockets provided on both sides of the opposite sidewalls of the hollow body. The engaging portions 51 are designed so as to match for engagement with the first engaging portion 11 of the tube member 10. The body of the connection member 50 comprises an electrically conductive module which comprises the positive and negative conductive pieces 61 and 62, and the positive and negative conductive pieces 61 and 62 are respectively provided in the inside and the outside of the fixed column 60. The positive and elastic negative contact pieces 610 and 620 are respectively formed at the two ends of the positive and negative conductive pieces 61 and 62, which are respectively positioned within the engaging portions 51. The positive and negative contacts 211 and 221 within the first engaging portion 11 of the tube member 10 are respectively electrically connected with the positive and elastic negative contact pieces 610 and 620 within the engaging portion 51 of the connection member 50 while the first engaging portion 11 of the tube member 10 is engaged with the engaging portion 51 of the connection member 50. Therefore, when another tube member (not shown) is inserted into another engaging portion 51 of the connection member 50, the electricity can be supplied to another tube member which is electrically connected to the previous tube member 10 via the electrically conductive module of the connection member 50.

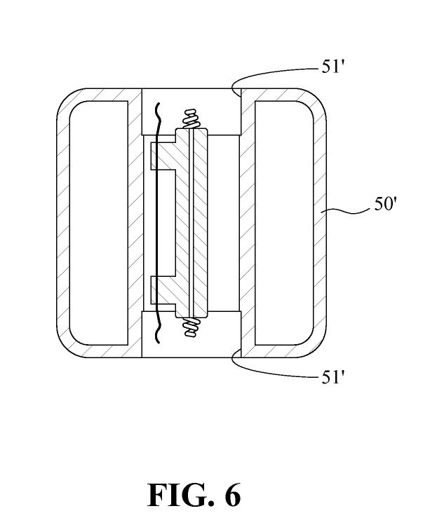

In the embodiment described above, the tube member 10 is a hollow cylindrical tube, and the first and the second engaging portions 11 and 12 are respectively formed at two ends thereof, and the first engaging portion 11 is receivable in engagement with the structure of the second engaging portion 12, and the connection member 50 has a cylindrical shape. Besides the above-mentioned embodiment, the tube member 10 can also be a square tube, and the engaging portions 11 and 12 of the tube member 10 can be in an annular shape or a square shape. As shown in FIG. 6, the connection member 50′ can have a rectangular shape, and the engaging portions 51′ of the connection member 50′ can be a round hole or a square hole which can be engaged with the first engaging portion 11 of the tube member 10.

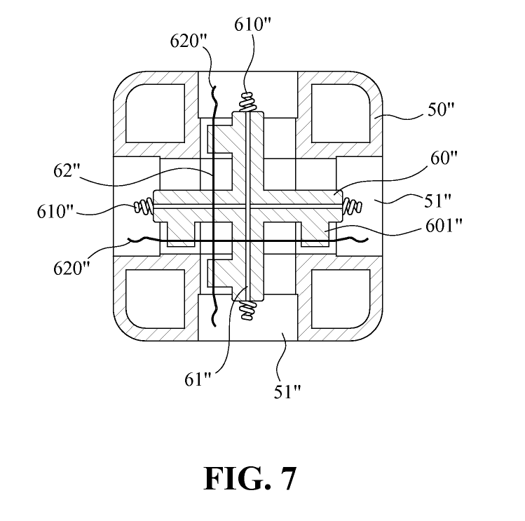

Referring to FIG. 7, in one embodiment, the connection member 50″ has a rectangular shape, and the body of the connection member has four symmetrical sidewalls, and the engaging portions 51″ is provided in each sidewall of the body. The connection member 50″ is hollow, and has an electrically conductive module, which comprises a positive and a negative conductive pieces 61″ and 62″ respectively positioned in the inside and the outside of the fixed column 60″. The fixed column 60″ is in a cross shape, and has four arms perpendicular to one another. Each of the arms has a distal end positioned within the inside of one of the engaging portions 51″. An affixing portion 601″ is disposed on each arm near the distal end thereof for fixing the negative conductive piece 62″. The positive conductive piece 61″ also has a cross shape and is enclosed in the fixed column 60″. Each arm of the positive conducting piece 61″ respectively extends out of its corresponding arm of the fixed column 60″ and has an elastic positive contact piece 610″ on the end of each arm of the positive conductive piece 61″. The negative conductive piece 62″ has a plurality of ends, and each end has an elastic negative contact piece 620″ positioned within the engaging portion 51″.

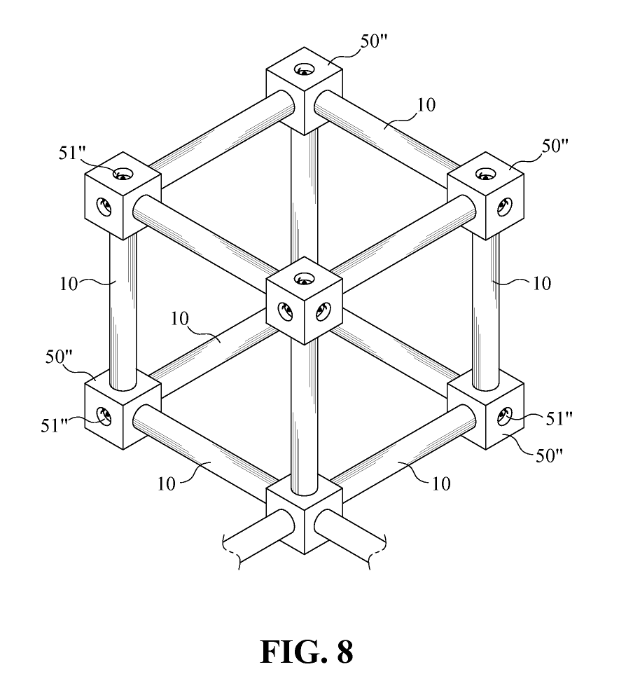

As described above, the connection member 50″ can receive the four tube members 10 in the four engaging portions 51″ on the four sides of the connection member 50″ to form a tube assembly. In another case, as shown in FIG. 8, the engaging portions 51″ are provided in the top side, bottom side, and four lateral sides of the connection member 50″ such that the tube members 10 can be engaged with the connection member 50″ to form a three-dimensional tube assembly. In this embodiment, when the engaging portions 51″ are respectively disposed on the top side, bottom side, and four sidewalls of the connection member 50″, the fixed columns along with their corresponding positive and negative conductive pieces will have a three-dimensional configuration.

In the preferred embodiment, the first and second engaging portions 11 and 12 of the tube member 10 have been respectively described as male plug and female socket so that the tube members 10 can be assembled together. A person skilled in the art will appreciate that other variations may be possible. For example, the first and second engaging portions of the tube member 10 all are male plugs, but in the other case, all are female sockets. Likewise, the engaging portions 51″ of the connection member, for example, all can be male plugs, or female sockets, or the combination of male plugs and female sockets. These engaging portions of the connection member can be arranged in different numbers and angles for assembling a plurality of tube members in a three-dimensional configuration.

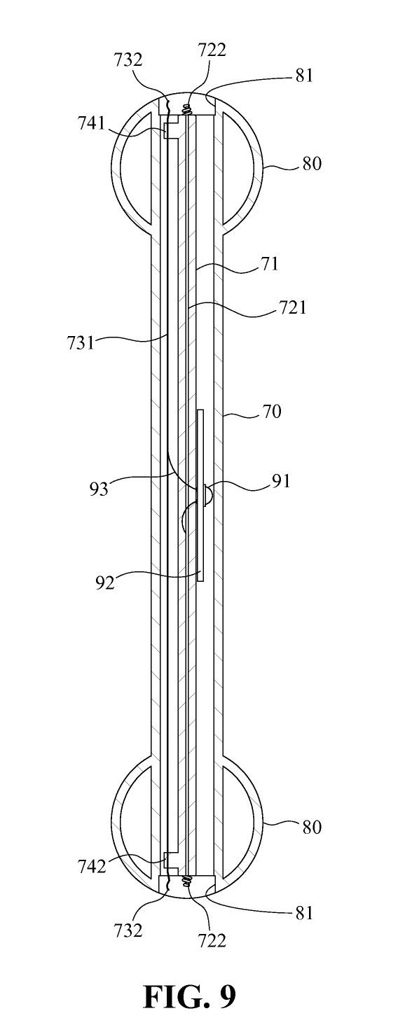

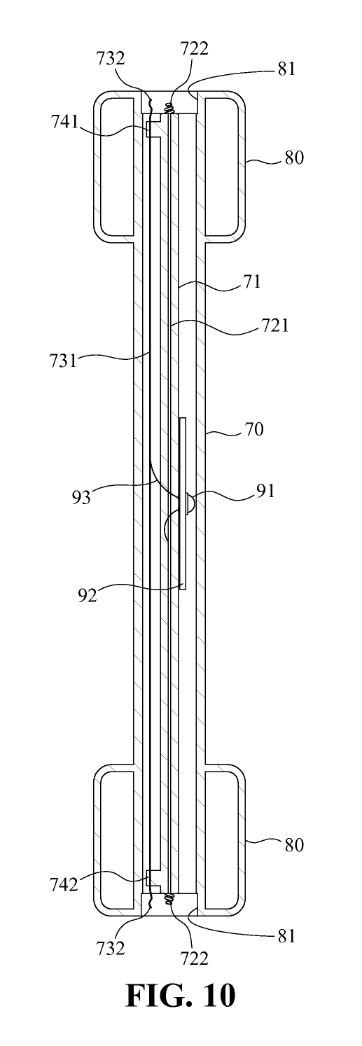

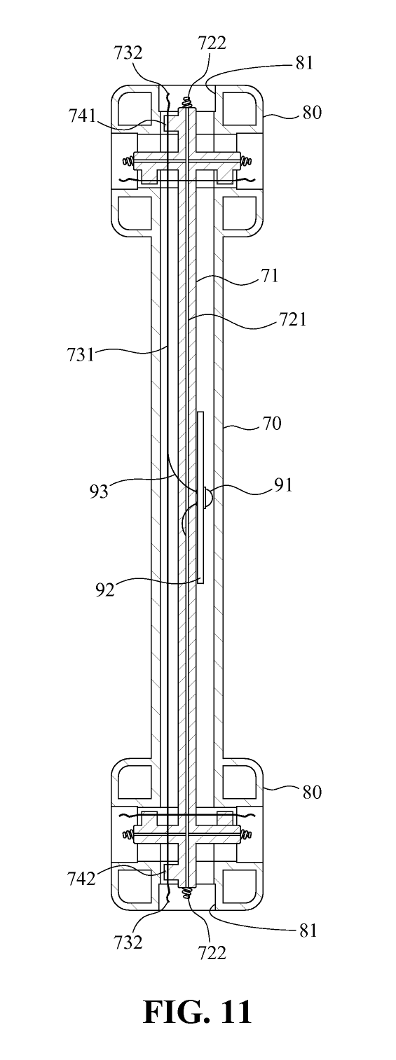

FIGS. 9, 10 and 11 are schematic views illustrating the other embodiment of the present invention. In this embodiment, the tube member 70 and the connection member 80 are integrally formed, and the connection member 80 integrally formed at the two ends of the tube member 70 can be in different shapes.

The tube member 70 extends through the connection member 80 to the engaging portion 81 of the connection member 80, and includes a fixed column 71, a positive conducting piece 721 and a negative conducting piece 731.

The positive conducting piece 721 is positioned in the inside of the fixed column 71, and has the positive contacts 722, which are in a spiral shape, respectively protrude out of the top and bottom surfaces of the fixed column 71, and are positioned within the engaging portions 81 of the connection member 80 integrally formed with the tube member 70.

The negative conducting piece 731 is affixed at the first and second affixing portions 741 and 742 of the fixed column 71. The negative conducting piece 731 has a negative contact 732 that is an elastic piece, and the negative contact 732 extends to the engaging portion 81 of the connection member 80 integrally formed with the tube member 70, and is positioned opposite the positive contact 722.

The interior of the tube member 70 also includes one or more light-emitting devices that are connected to the positive and negative conducting pieces 721 and 731. In the preferred embodiment, the light-emitting devices can be light-emitting diodes 91 that are mounted on a circuit board 92. The circuit board 92 is connected to the positive and negative conducting pieces 721 and 731 via the circuit wires 93.

When a tube member 70 integrally formed with a connection member 80 is assembled with the other tube member 70 integrally formed with the other connection member 80, the positive and negative contacts 722 and 732 of the tube member 70 will respectively contact with the other positive and negative contacts 722 and 732 of the other tube member 70 within the engaging portions 81, so that the light-emitting diode 91 mounted on the circuit board 92 will be illuminated when the electricity is supplied.

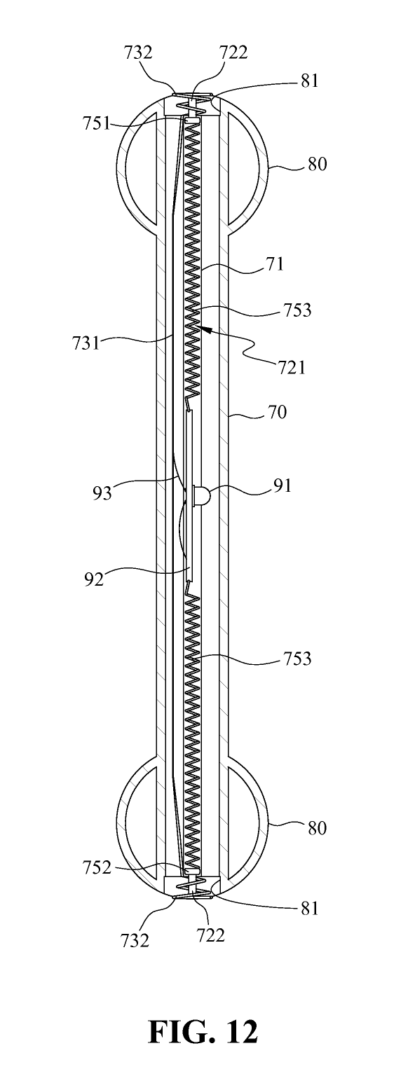

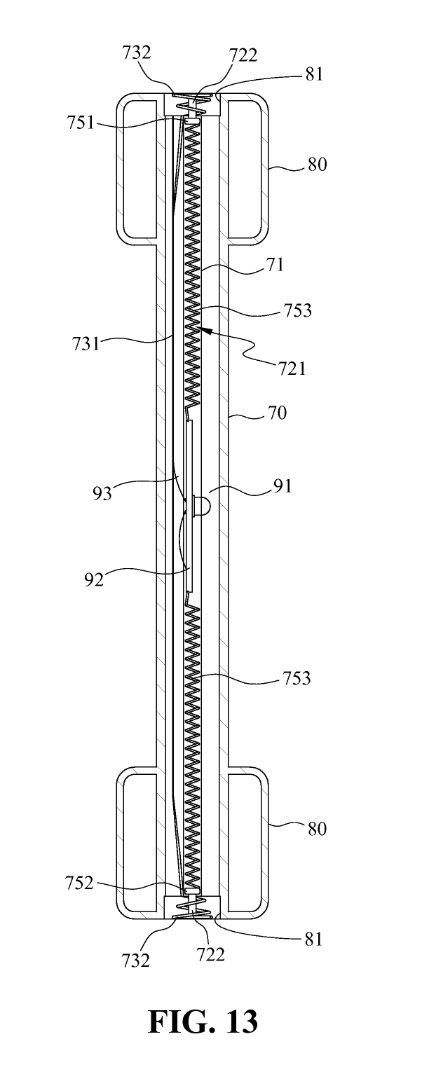

FIGS. 12 and 13 illustrate another embodiment that is generally similar to the previous embodiment except the structures of the positive and negative conducting pieces.

In this embodiment, the positive and negative conducting pieces 721 and 731 are disposed in the inside and the outside of the fixed column 71. The fixed column 71 is hollow. The positive conducting piece 721 is consisted of an upper conductive pin 751, a lower conductive pin 752, and an upper and a lower spring 753. One end of the upper conductive pin 751 and one end of lower conductive pin 752 protrude out of two ends of the fixed column 71 to respectively form the first and the second positive contacts 722, and the other ends of the upper and lower conductive pins 751 and 752 are respectively in contact with the upper and lower springs 753 so that the upper and lower conductive pins 751 and 752 are retractable and extendible. The springs 753 are also electrically connected to the circuit board 92 and the light-emitting diodes 91, which is mounted on the circuit board 92.

Two negative contacts 732 in the form of coil spring are respectively formed at the two ends of the negative conducting piece 731. The coil spring serving as the negative contact 732 is in a reverse cone shape, which has a diameter that decreases from top to bottom, and the two negative contacts 732 in the form of coil spring are surrounded around the upper and lower conductive pins 751 and 752.

The engaging portions can be designed as male plug or female socket so that the tube members can be assembled together. A person skilled in the art will appreciate that other variations may be possible. For example, the engaging portions all are male plugs, or all are female sockets, or the combination of male plugs and female sockets. These engaging portions can be arranged in different numbers and angles for assembling a plurality of tube members in a three-dimensional configuration.

A number of embodiments of the present invention have been described. Nevertheless, it will be understood that various modifications may be made without departing from the spirit and scope of the invention. Accordingly, it is to be understood that the invention is not to be limited by the specific illustrated embodiment but only by the scope of the appended claims.

What is claimed is:

1. A tube assembly having an electrical connection structure, comprising:
a tube member, being hollow and light-transmittable, the tube member having two opposite ends respectively formed with a first engaging portion and a second engaging portion, and including an electrical module and at least one light-emitting device positioned therein, the electrical module including a positive conducting piece and a negative conducting piece, the positive and negative conducting pieces being respectively electrically connected to the at least one light-emitting device, the positive conducting piece having two opposite ends respectively formed with a first positive contact and a second positive contact, the negative conducting piece having two opposite ends respectively formed with a first negative contact and a second negative contact, and the positive and negative contacts being respectively positioned within the first and second engaging portions of the tube member; and
a connection member, including a hollow body provided with at least two engaging portions, the at least two engaging portions being engageable with the first engaging portion of the tube member, the hollow body comprising an electrically conductive module, the electrically conductive module including a positive conducting piece and a negative conducting piece, the positive conducting piece having two opposite ends respectively formed with a positive contact piece, the negative conducting piece having two opposite ends respectively formed with a negative contact piece, the positive and elastic negative contact pieces being respectively positioned within the engaging portions of the connection member.

2. The tube assembly of claim 1, wherein the positive conducting piece and the negative conducting piece respectively positioned in an inside and an outside of a fixed column, and the positive and negative conducting pieces are insulated from each other.

3. The tube assembly of claim 2, wherein the positive conducting piece positioned in the inside of the fixed column extends in an axial direction, and the positive conducting piece has two opposite ends that respectively form a first positive contact and a second positive contact, wherein the first positive contact is positioned on a top of the fixed column, and the second positive contact protrudes out of a bottom surface of the fixed column.

4. The tube assembly of claim 3, wherein the negative conducting piece has a strip shape, and includes an outer circumferential wall and an inner circumferential wall, wherein the outer circumferential wall has an outer diameter that matches with an inner diameter of the first engaging portion so that the outer circumferential wall contacts with an inner sidewall of the first engaging portion, and a central region of the first negative contact has a through-hole, and the first negative contact is mounted around an upper portion of the fixed column.

5. The tube assembly of claim 4, wherein the at least one light-emitting device is a light-emitting diode mounted on a circuit board, and the circuit board including a plurality of conducting wires electrically connected to the positive and negative conducting pieces of the electrical module.

6. The tube assembly of claim 1 wherein two of the at least two engaging portions are positioned at two opposite sides of the connection member.

7. The tube assembly of claim 1, wherein the fixed column is hollow, and the positive conducting piece includes an upper conductive pin, a lower conductive pin, and at least one spring, and one end of the upper pin and one end of the lower conductive pin protrude out of two ends of the fixed column to respectively form a first positive contact and a second positive contact.

8. The tube assembly of claim 1, wherein the negative conducting piece has two opposite ends respectively formed with one negative contact as coil spring, and the two negative contacts as coil spring are respectively surrounded around the upper and lower conductive pins.

9. A tube assembly having an electrical connection structure, comprising:
a tube member having two opposite ends respectively integrally formed with a connection member, the tube member integrally formed with the connection member further comprising:
a positive conducting piece having at least one positive contact positioned within engaging portions of the connection member integrally formed with the tube member;
a negative conducting piece having at least one negative contact positioned within the engaging portions of the connection member integrally formed with the tube member, the negative conducting piece being disposed opposite to the positive conducting piece; and
at least one light-emitting device electrically connected to the positive and negative conducting pieces.

10. The tube assembly of claim 9, wherein the positive conducting piece and the negative conducting piece respectively positioned in an inside and an outside of a fixed column, and the positive and negative conducting pieces are insulated from each other.

11. The tube assembly of claim 10, wherein the positive conducting piece positioned in the inside of the fixed column extends in an axial direction, and the positive conducting piece has a first positive contact and a second positive contact, wherein the first positive contact is positioned on a top of the fixed column, and the second positive contact is positioned on a bottom of the fixed column.

12. The tube assembly of claim 11, wherein two opposite ends of the fixed column respectively formed with a first affixing portion and a second affixing portion, the negative conducting piece is affixed to the first and second affixing portions of the fixed column, the negative contacts of the negative conducting piece extend to and within the engaging portions of the tube member.

13. The tube assembly of claim 9, wherein the fixed column is hollow, and the positive conducting piece includes an upper conductive pin, a lower conductive pin, and at least one spring, and one end of the upper pin and one end of the lower conductive pin protrude out of two ends of the fixed column to respectively form a first positive contact and a second positive contact.

14. The tube assembly of claim 9, wherein the negative conducting piece has two opposite ends respectively formed with one negative contact as coil spring, and the two negative contacts as coil spring are respectively surrounded around the upper and lower conductive pins.

15. The tube assembly of claim 9, wherein the at least one light-emitting device is a light-emitting diode mounted on a circuit board, and the circuit board including a plurality of conducting wires electrically connected to the positive and negative conducting pieces.

16. The tube assembly of claim 9, wherein the tube member having the two opposite ends respectively integrally formed with the connection member is assembled with the other tube member having the two opposite ends respectively integrally formed with the other connection member, and the at least one positive contact and the at least one negative contact of the tube member integrally formed with the connection member are respectively in contact with the other at least one positive contact and the other at least one negative contact of the other tube member integrally formed with the other connection member within the engaging portions.
